(19) United States
(12) Patent Application Publication
(10) Pub. No.: US 2025/0249402 A1
(43) Pub. Date: Aug. 7, 2025

(54) SYSTEMS AND METHODS FOR ELIMINATING FLARING IN AMINE SWEETENING

(71) Applicant: Saudi Arabian Oil Company, Dhahran (SA)

(72) Inventors: Mohammed A. Rumaih, Saihat (SA); Ali H. Bubshait, Dammam (SA); Hussain A. Ali, Al Umran (SA); Tariq S. Sultan, Al-Ahsa (SA)

(73) Assignee: Saudi Arabian Oil Company, Dhahran (SA)

(21) Appl. No.: 18/432,283

(22) Filed: Feb. 5, 2024

(51) Int. Cl. B01D 53/75; B01D 53/14; B01D 53/18

(52) U.S. Cl. CPC B01D 53/75; B01D 53/1468; B01D 53/1475; B01D 53/18; B01D 2252/204; B01D 2257/304; B01D 2257/504; B01D 2258/0283

(57) ABSTRACT

A process for eliminating flaring in amine sweetening comprises separating a hydrocarbon stream into a saturated liquid condensate stream and an acid gas stream; depressurizing the saturated liquid condensate stream to form a gas flaring stream and a liquid condensate stream; contacting the acid gas stream with a lean amine stream to form a sweet gas stream and a rich amine stream; sending the gas flaring stream to one or more sparge tubes in a flash drum; sparging the rich amine stream with the gas flaring stream in the flash drum to form a flashed rich amine stream and a flashed gas stream; and stripping the rich amine stream to form a stripped acid gas stream and the lean amine stream.

### TECHNICAL FIELD

The present disclosure relates to processes and systems for amine sweetening, and more specifically to systems and processes for eliminating flaring in amine sweetening.

### BACKGROUND

The presence of corrosive species such as hydrogen sulfide, carbon dioxide, organic acids, and brine solutions in produced hydrocarbons can create an aggressively corrosive environment for transportation pipelines and hydrocarbon processing facilities in the oil and gas industry. Once dissolved in water, both CO₂ and H₂S behave like weak acids and can cause oxidation, which promotes steel corrosion. This corrosion can cause severe damage on the internal walls of production and transportation pipelines, which are mostly steel-based materials. Corrosion leads to many risks, such as pipeline leakages and even bursting, resulting in unplanned turnaround maintenance time and costs. Generally, hydrocarbons containing these corrosive species may be commonly referred to as ‘acid gases’ or ‘sour’, whereas the same hydrocarbons without the corrosive species or the after removal of the same are referred to as ‘sweet’.

### SUMMARY

Accordingly, it may be desired to remove these sour/corrosive species from produced hydrocarbons to avoid potential corrosion problems, as well as to increase the economic value of the hydrocarbons. Amine sweetening, also known as amine gas treating, amine scrubbing, gas sweetening, or acid gas removal, is a well-known process that uses aqueous solutions of various amines to remove the aforementioned corrosive species from produced hydrocarbons, such as acid gas or sour gas streams. Flaring (combustion of the gases in a controlled manner) is primarily used to dispose of these separated acid gas or sour gas streams, as there is not otherwise a recognized use for the same. However, flaring is one of the major sources of carbon emissions worldwide. In 2021, approximately 144 billion cubic meters of gas, hydrocarbon or otherwise, was flared, resulting in over 400 million tons of CO₂ emissions globally. With ongoing concerns regarding global climate change, innovative solutions are required to reduce the presence and/or amount of flaring in general. Moreover, the Zero Routine Flaring Initiative (ZRF Initiative), launched in 2015, has committed various governments and oil companies to end routine flaring of natural gas by 2030.

Accordingly, methods are desired to remove sour/corrosive species from produced hydrocarbons that do not require the flaring of gas, and further utilize the sour/corrosive species in a beneficial manner in amine sweetening. Consequently, systems and processes herein redirect ordinarily flared gases into a flash drum of amine sweetening as a sparging medium. The use of the ordinarily flared gas as a sparging medium enables the separation of greater amounts of entrained hydrocarbons in the rich amine stream, thereby also decreasing the risks of stripper column foaming. Further, the use of the ordinarily flared gas as a sparging medium reduces the required replacement frequency of additional separation mediums such as an activated carbon bed in an optional filtration column. The ordinarily flared gas exiting the flash drum may then be disposed of in an injection well, eliminating flaring in amine sweetening.

In accordance with one embodiment herein, a process for eliminating flaring in amine sweetening comprises separating a hydrocarbon stream into a saturated liquid condensate stream and an acid gas stream; depressurizing the saturated liquid condensate stream to form a gas flaring stream and a liquid condensate stream; contacting the acid gas stream with a lean amine stream to form a sweet gas stream and a rich amine stream; sending the gas flaring stream to one or more sparge tubes in a flash drum; sparging the rich amine stream with the gas flaring stream in the flash drum to form a flashed rich amine stream and a flashed gas stream; and stripping the rich amine stream to form a stripped acid gas stream and the lean amine stream.

In accordance with another embodiment herein, a system for eliminating flaring in amine sweetening comprises a feed separator; a blowdown drum fluidly connected to and downstream from the feed separator; an amine absorption unit fluidly connected to and downstream from the feed separator; a flash drum fluidly connected to and downstream from the amine absorption unit and the blowdown drum; and a stripper column fluidly connected to and downstream from the flash drum, and additionally fluidly connected to and upstream from the amine absorption unit, and wherein the flash drum further comprises one or more sparge tubes configured to accept a gas flaring stream from the flash drum and to sparge a rich amine stream from the amine absorption unit.

Additional features and advantages of the described embodiments will be set forth in the detailed description, which follows, and in part will be readily apparent to those skilled in the art from that description or recognized by practicing the described embodiments, including the detailed description, which follows, as well as the claims.

### BRIEF DESCRIPTION OF THE DRAWINGS

The following detailed description of specific embodiments of the present disclosure can be best understood when read in conjunction with the following drawings in which:

FIG. 1 illustrates a process flow diagram for an exemplary process in accordance with embodiments herein; and

FIG. 2 illustrates an exemplary flash drum with one or more sparge tubes, in accordance with embodiments herein.

For the purpose of describing the simplified schematic illustrations and descriptions of the relevant figures, the numerous valves, temperature sensors, electronic controllers and the like that may be employed and well known to those of ordinary skill in the art of certain chemical processing operations are not included. Further, accompanying components that are often included in typical chemical processing operations, such as air supplies, catalyst hoppers, and flue gas handling systems, are not depicted. Accompanying components that are in hydrotreating units, such as bleed streams, spent catalyst discharge subsystems, and catalyst replacement sub-systems are also not shown. It should be understood that these components are within the spirit and scope of the present embodiments disclosed. However, operational components, such as those described in the present disclosure, may be added to the embodiments described in this disclosure.

It should further be noted that arrows in the drawings refer to process streams. However, the arrows may equivalently refer to transfer lines, which may serve to transfer process streams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows, which do not connect two or more system components, signify a product stream, which exits the depicted system, or a system inlet stream, which enters the depicted system. Product streams may be further processed in accompanying chemical processing systems or may be commercialized as end products. System inlet streams may be streams transferred from accompanying chemical processing systems or may be non-processed feedstock streams. Some arrows may represent recycle streams, which are effluent streams of system components that are recycled back into the system. However, it should be understood that any represented recycle stream, in some embodiments, may be replaced by a system inlet stream of the same material, and that a portion of a recycle stream may exit the system as a product.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component.

It should be understood that according to the embodiments presented in the relevant figures, an arrow between two system components may signify that the stream is not processed between the two system components. In other embodiments, the stream signified by the arrow may have substantially the same composition throughout its transport between the two system components. Additionally, it should be understood that in embodiments, an arrow may represent that at least 75 wt. %, at least 90 wt. %, at least 95 wt. %, at least 99 wt. %, at least 99.9 wt. %, or even 100 wt. % of the stream is transported between the system components. As such, in embodiments, less than all of the stream signified by an arrow may be transported between the system components, such as if a slip stream is present.

It should be understood that two or more process streams are “mixed” or “combined” when two or more lines intersect in the schematic flow diagrams of the relevant figures. Mixing or combining may also include mixing by directly introducing both streams into a like reactor, separation unit, or other system component. For example, it should be understood that when two streams are depicted as being combined directly prior to entering a separation unit or reactor, that in embodiments the streams could equivalently be introduced into the separation unit or reactor and be mixed in the reactor. Alternatively, when two streams are depicted to independently enter a system component, they may in embodiments be mixed together before entering that system component.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

As used herein, “sparge” or “sparging” refers to a concept in which a gas is bubbled through a liquid to remove dissolved gases and/or dissolved volatile liquids from that liquid. For example, and in embodiments, when a first stream is sparged with a second stream, the second stream is injected into, and bubbled through, the first fluid.

It should be understood that an “effluent” generally refers to a stream that exits a system component such as a separation unit, a reactor, or reaction zone, following a particular reaction or separation, and generally has a different composition (at least proportionally) than the stream that entered the separation unit, reactor, or reaction zone.

As used herein, a “separation unit” or “separator” refers to any separation device that at least partially separates one or more chemicals that are mixed in a process stream from one another. For example, a separation unit may selectively separate differing chemical species, phases, or sized material from one another, forming one or more chemical fractions. Examples of separation units include, without limitation, distillation columns, flash drums, knock-out drums, knock-out pots, centrifuges, cyclones, filtration devices, traps, scrubbers, expansion devices, membranes, solvent extraction devices, and the like. It should be understood that separation processes described in this disclosure may not completely separate all of one chemical constituent from all of another chemical constituent. It should be understood that the separation processes described in this disclosure “at least partially” separate different chemical components from one another, and that even if not explicitly stated, it should be understood that separation may include only partial separation. As used herein, one or more chemical constituents may be “separated” from a process stream to form a new process stream. Generally, a process stream may enter a separation unit and be divided, or separated, into two or more process streams of desired composition. Further, in some separation processes, a “lower boiling point fraction” (sometimes referred to as a “light fraction” or “light fraction stream”) and a “higher boiling point fraction” (sometimes referred to as a “heavy fraction,” “heavy hydrocarbon fraction,” or “heavy hydrocarbon fraction stream”) may exit the separation unit, where, on average, the contents of the lower boiling point fraction stream have a lower boiling point than the higher boiling point fraction stream. Other streams may fall between the lower boiling point fraction and the higher boiling point fraction, such as a “medium boiling point fraction.”

It should further be understood that streams may be named for the components of the stream, and the component for which the stream is named may be the major component of the stream (such as comprising from 50 weight percent (wt. %), from 70 wt. %, from 90 wt. %, from 95 wt. %, from 99 wt. %, from 99.5 wt. %, or even from 99.9 wt. % of the contents of the stream to 100 wt. % of the contents of the stream). It should also be understood that components of a stream are disclosed as passing from one system component to another when a stream comprising that component is disclosed as passing from that system component to another. By way of non-limiting example, a referenced “hydrocarbon stream” passing from a first system component to a second system component should be understood to equivalently disclose “hydrocarbons” passing from a first system component to a second system component, and the like.

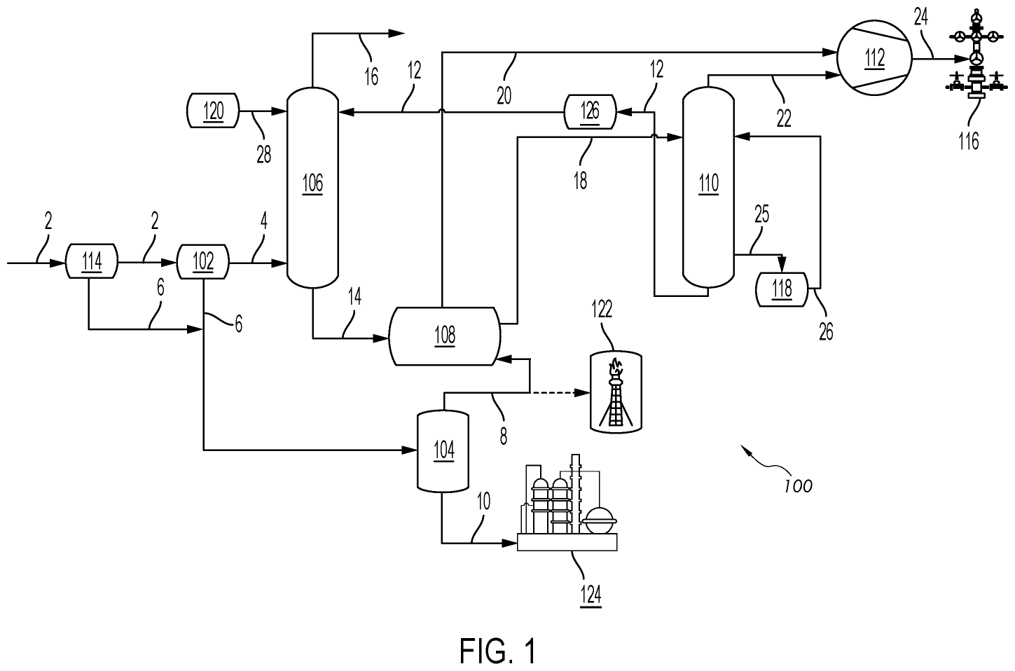

As previously stated, embodiments herein are directed to processes and systems for eliminating flaring in amine sweetening, as described below. Referring initially to FIG. 1, a system 100 for eliminating flaring in amine sweetening is illustrated. The system 100 may comprises a feed separator 102, a blowdown drum 104, an amine absorption unit 106, a flash drum 108, and a stripper column 110.

The feed separator 102 may be configured to separate a hydrocarbon stream 2 into a saturated liquid condensate stream 6 and an acid gas stream 4. The hydrocarbon stream 2 and the acid gas stream 4 may comprise a hydrocarbon component and an acid gas component. The acid gas component may comprise hydrogen sulfide, carbon dioxide, any gas that may render a neutral pH aqueous solution acidic when dissolved within, or combinations thereof.

The blowdown drum 104 may be fluidly connected to, and downstream from, the feed separator 102. The blowdown drum 104 may be configured to depressurize the saturated liquid condensate stream 6 and form a gas flaring stream 8 and a liquid condensate stream 10. The liquid condensate stream 10 may comprise primarily liquid hydrocarbon fractions and the gas flaring stream 8 may comprise primarily gas hydrocarbon fractions, acid gas fractions, or both. In some embodiments, the system 100 may further comprise a liquid hydrocarbon refinery 124, which may be downstream of the blowdown drum 104 and may be configured to accept the liquid condensate stream 10 and conduct one or more further upgrading or refining operations.

In some embodiments, a slug catcher 114 may be fluidly connected and upstream of the feed separator 102 and the blowdown drum 104. The slug catcher 114 may be configured to receive the hydrocarbon stream 2 and separate at least a portion of the saturated liquid condensate stream 6 from the hydrocarbon stream 2 prior to the feed separator 102. This additional saturated liquid condensate stream 6 may then also be received at the blowdown drum 104.

The amine absorption unit 106 may be fluidly connected to the feed separator 102. The amine absorption unit 106 may be configured to process the acid gas stream 4 and a lean amine stream 12 to form a sweet gas stream 16 and a rich amine stream 14. The acid gas stream 4 may comprise a relatively large amount of the acid gas component, such as from 1 wt. % to 99 wt. % acid gas component, measured by the weight of the acid gas stream 4. The acid gas stream 4, as used herein, may also be referred to herein as a “sour gas stream” such as in those situations in which the acid gas stream 4 includes a relatively large amount of hydrogen sulfide as the acid gas component, as may be understood in the art. The lean amine stream 12 may include amines in an aqueous solution, the amine including diethanoloamine, monoethanoloamine, methyldiethanolamine, diisopropanolamine, aminoethoxyethanol, any other amine known in the art, or combinations thereof.

In some embodiments, and referring again to FIG. 1, the system 100 may further comprise a water source 120. The water source 120 may be fluidly connected to and upstream of the amine absorption unit 106. The water source 120 may be configured to supply a water stream 28 to the amine absorption unit 106. The water source 120 may supply the water stream 28 to a top portion of the amine absorption unit 106, wherein the water stream 28 may ‘water wash’ the sweet gas stream 16, thereby absorbing entrained amines from the lean amine stream 12 present in the sweet gas stream 16 and forming a water washed sweet gas stream 16. Without being limited by theory, this may operate to remove amines in the sweet gas stream 16 and increase the amount of amines recirculating within the system 100.

For example, and in embodiments, the amine absorption unit 106 may further comprise an amine absorption section and a water washing section. The water washing section may be in fluid communication with and disposed above the amine absorption section. The amine absorption section may be configured to process the acid gas stream 4 with the lean amine stream 12 to generate the rich amine stream 14 comprising acid gas entrained in the same and the sweet gas stream 16 comprising amines entrained in the same.

In embodiments, the sweet gas stream 16 may comprise from 0.1 wt. % to 10 wt. % amines measured by weight of the sweet gas stream 16. The water washed sweet gas stream 16 may comprise a relatively lesser amount of amines than the sweet gas stream 16, which, without being limited by theory, may be attributable to the water washing.

Still referring to FIG. 1, and as previously stated, the system 100 may further comprise the flash drum 108. The flash drum 108 may be fluidly connected to and downstream from the amine absorption unit 106 and the blowdown drum 104. The flash drum 108 may be configured to accept the rich amine stream 14 and process the same to form a flashed rich amine stream 18 and a flashed gas stream 20.

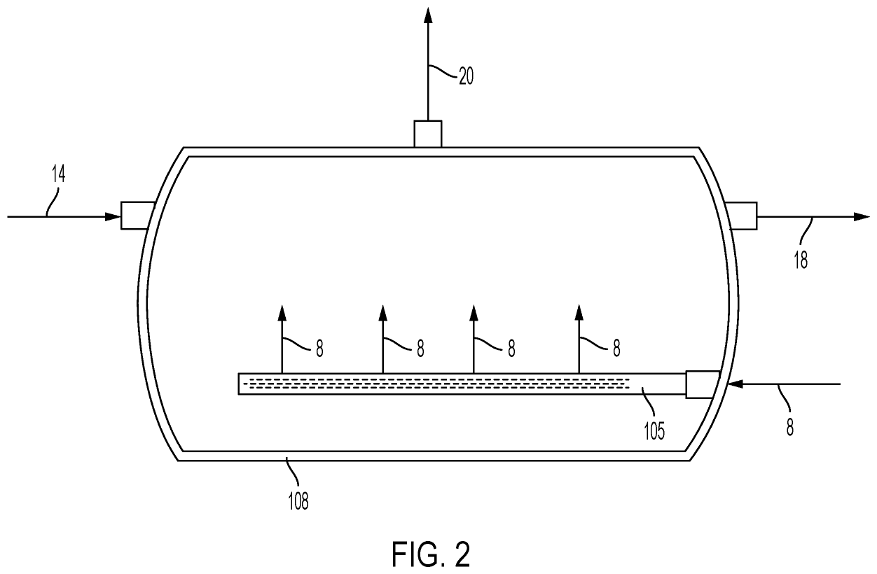

As shown in FIG. 2, the flash drum 108 may also comprise one or more sparge tubes 109, the one or more sparge tubes 109 of which may receive the gas flaring stream 8. In so having, the flash drum 108 may also be configured to sparge the rich amine stream 14 with the gas flaring stream 8, forming additional flashed gas stream 20 and removing entrained hydrocarbons from the rich amine stream 14. Without being limited by theory, reducing the amount of entrained hydrocarbons in the rich amine stream 14 may reduce the chance of foaming occurring in the stripper column 110 and/or the amine absorption unit 106, and thus may reduce the absorption duty of one or more activated carbon beds of a filtration column 126, as explained in further detail below. Further, without being limited by theory, in being configured as above, the flash drum 108 may receive the gas that would ordinarily be flared in a flare stack 122, providing a use for gas that would otherwise be flared/disposed of.

As previously discussed, the system 100 may also comprise the stripper column 110, which may also be referred to as a regenerator. The stripper column 110 may be fluidly connected to and downstream from the flash drum 108, as well as being fluidly connected to and upstream of the amine absorption unit 106. The stripper column 110 may be configured to process the flashed rich amine stream 18 to form the lean amine stream 12 and a stripped acid gas stream 22.

In embodiments, the flashed rich amine stream 18 may enter through top portion of the stripper column 110. The flashed rich amine stream 18 may then pass in a down-flow manner through the stripper column 110, contacting an up-flow steam stream. The up-flow steam stream may operate to strip at least a portion of the acid gas component from the rich amine stream 14 to form the stripped acid gas stream 22 and the lean amine stream 12.

In some embodiments, and as previously discussed, the system 100 may further comprise a filtration column 126. The filtration column 126 may be fluidly connected to and downstream of the stripper column 110, and may be configured to receive the lean amine stream 12 from the stripper column 110. As previously stated, the filtration column 126 may further comprise one or more activated carbon beds. Without being limited by theory, the one or more activated carbon beds may be configured to remove (by absorption or otherwise) at least a portion of residual hydrocarbons in the lean amine stream 12. However, in at least some embodiments, the lean amine stream 18 may be sent directly from the stripper column to the amine absorption column 106, i.e., the filtration column 126 may be optional. In some embodiments, the filtration column 126 may also comprise particulate filters disposed on either side of the one or more activated carbon beds.

As previously stated, and without being limited by theory, the inclusion of the sparge tubes 109 may reduce the required replacement frequency/adsorption duty of the one or more activated carbon beds of the filtration column 126. This may also in turn increase the acid gas adsorption effectiveness of the lean amine stream 12 in the amine absorption column 106, thus improving efficiency of the system as a whole.

Still referring to FIG. 1, and in embodiments, the system 100 may also comprise a re-boiler unit 118 fluidly connected to the stripper column 110, and may be both downstream and upstream of the same. The stripper column 110 may be additionally configured to send a stripper column effluent stream 25 to the re-boiler unit 118. The stripper column effluent stream 25 may be obtained from the settled portions of the flashed rich amine stream 18, and particularly the aqueous portion of the same. The re-boiler unit 118 may be configured to supply energy in the form of heat to the stripper column effluent stream 25 to form a water vapor stream 26. The re-boiler unit 118 may be further configured to send the water vapor stream 26 back to the stripper column 110, which may operate to form the up-flowing steam stream comprising the water vapor stream 26 within the stripper column 110. The up-flowing steam stream may then contact the flashed rich amine stream 18, as previously described, thereby stripping at least a portion of the acid gas component from the previous and forming additional stripped acid gas stream 22 and lean amine stream 12.

Still referring to FIG. 1, the system 100 may also comprise a compressor 112, which may be fluidly connected to, and downstream from, the stripper column 110 and the flash drum 108. The compressor 112 may be configured to receive the flashed gas stream 20 and the stripped acid gas stream 22. The compressor 122 may also be configured to compress the flashed gas stream 20 and the stripped acid gas stream 22 for injection into an injection well 116 as a disposal stream 24. The injection well 116 may be fluidly connected to and upstream of the flash drum 108, the stripper column 110, or both.

As previously stated, embodiments herein may also include processes for eliminating flaring in amine sweetening. The process may comprise any of the systems 100 previously discussed. The process may comprise separating the hydrocarbon stream 2 into the saturated liquid condensate stream 6 and the acid gas stream 4, such as in the feed separator 102. However, in some embodiments, the process may initially comprise separating at least a portion of the saturated liquid condensate stream 6 from the hydrocarbon stream 2 prior to separating the hydrocarbon stream 2 into the saturated liquid condensate stream 6 and the acid gas stream 4.

The process may further comprise depressurizing the saturated liquid condensate stream 6 to form the gas flaring stream 8 and the liquid condensate stream 10, such as in the blowdown drum 104. The process may also comprise contacting the acid gas stream 4 with the lean amine stream 12 to form the sweet gas stream 16 and the rich amine stream 14, such as in the amine absorption unit 106. In some embodiments, as previously discussed, the amine absorption unit 106 may further comprise the amine absorption section and the water washing section. In turn, the process may further comprise contacting the sweet gas stream 16 with the water stream 28 in the water washing section to form the water washed sweet gas stream 16 and additional rich amine stream 14. The process may also comprise contacting the acid gas stream 4 and the lean amine stream 12 in the amine absorption section to form the sweet gas stream 16 and the rich amine stream 14.

The process may also comprise sending the gas flaring stream 8 to the one or more sparge tubes 109 in the flash drum 108. The process may then comprise sparging the rich amine stream 14 with the gas flaring stream 8 in the flash drum 108 to form the flashed rich amine stream 18 and the flashed gas stream 20. The process may then comprise stripping the rich amine stream 14 and optionally the water vapor stream 26 to form the stripped acid gas stream 22 and the lean amine stream 12, such as in the stripper column 110. In some embodiments, stripping the rich amine stream 14 may additionally form the stripper column effluent stream 25. In these embodiments, the process may further comprise sending the stripper column effluent stream 25 to the re-boiler unit 118. The process may also comprise heating the stripper column effluent stream 25 in the re-boiler unit 118 to form the water vapor stream 26 and sending the water vapor stream 26 to the stripper column 110 to form additional stripped acid gas stream 22 and additional lean amine stream 12.

In at least some embodiments, the process may further comprise sending the lean amine stream 12 from the stripper column 110 to the filtration column 126 comprising the one or more activated carbon beds. The process may also comprise contacting the one or more activated carbon beds with the lean amine stream 12, thereby removing at least a portion of residual hydrocarbons in the lean amine stream 12. The method may also comprise sending the lean amine stream 12 to the amine absorption unit 106.

In some embodiments, the process may further comprise sending the flashed gas stream 20 and the stripped acid gas stream 22 to the compressor 112, injecting the flashed gas stream 20 and the stripped acid gas stream 22 into the injection well 116, or both, such as by utilizing the compressor 112 to inject.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is also noted that recitations herein of “at least one” component, element, etc., should not be used to create an inference that the alternative use of the articles “a” or “an” should be limited to a single component, element, etc.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. A process for eliminating flaring in amine sweetening, the process comprising:
separating a hydrocarbon stream into a saturated liquid condensate stream and an acid gas stream;
depressurizing the saturated liquid condensate stream to form a gas flaring stream and a liquid condensate stream;
contacting the acid gas stream with a lean amine stream to form a sweet gas stream and a rich amine stream;
sending the gas flaring stream to one or more sparge tubes in a flash drum;
sparging the rich amine stream with the gas flaring stream in the flash drum to form a flashed rich amine stream and a flashed gas stream; and
stripping the rich amine stream to form a stripped acid gas stream and the lean amine stream.

2. The process of claim 1, wherein:
separating the hydrocarbon stream occurs in a feed separator;
depressurizing the saturated liquid condensate stream occurs in a blowdown drum;
contacting the acid gas stream with the lean amine stream occurs in an amine absorption unit; and
stripping the rich amine stream occurs in a stripper column.

3. The process of claim 1, further comprising separating at least a portion of the saturated liquid condensate stream from the hydrocarbon stream in a slug catcher prior to separating the hydrocarbon stream into the saturated liquid condensate stream and the acid gas stream.

4. The process of claim 1, further comprising sending the flashed gas stream and the stripped acid gas stream to a compressor.

5. The process of claim 4, further comprising injecting the flashed gas stream and the stripped acid gas stream into an injection well utilizing the compressor.

6. The process of claim 3, further comprising:
sending the lean amine stream from the stripper column to a filtration column comprising one or more activated carbon beds;
contacting the one or more activated carbon beds with the lean amine stream, thereby removing at least a portion of residual hydrocarbons in the lean amine stream; and
sending the lean amine stream to the amine absorption unit.

7. The process of claim 6, wherein the filtration column further comprises particulate filters disposed on either side of the one or more activated carbon beds of the filtration column.

8. The process of claim 1, wherein:
contacting the acid gas stream with the lean amine stream occurs in an amine absorption unit;
the amine absorption unit further comprises an amine absorption section and a water washing section; and
the process further comprises contacting the sweet gas stream with a water stream in the water washing section to form a water washed sweet gas stream and additional rich amine stream.

9. The process of claim 1, wherein the acid gas stream comprises hydrogen sulfide, carbon dioxide, or both.

10. The process of claim 1, wherein the lean amine stream comprises an amine in an aqueous solution.

11. The process of claim 1, further comprising:
sending a stripper column effluent stream comprising water to a re-boiler unit, wherein stripping the rich amine stream further forms the stripper column effluent stream;
heating the stripper column effluent stream in the re-boiler unit to form a water vapor stream; and
sending the water vapor stream to the stripper column to form additional stripped acid gas stream and additional lean amine stream.

12. A system for eliminating flaring in amine sweetening, the system comprising:
a feed separator;
a blowdown drum fluidly connected to and downstream from the feed separator;
an amine absorption unit fluidly connected to and downstream from the feed separator;
a flash drum fluidly connected to and downstream from the amine absorption unit and the blowdown drum; and
a stripper column fluidly connected to and downstream from the flash drum, and additionally fluidly connected to and upstream from the amine absorption unit, and wherein
the flash drum further comprises one or more sparge tubes configured to accept a gas flaring stream from the flash drum and to sparge a rich amine stream from the amine absorption unit.

13. The system of claim 12, further comprising a slug catcher fluidly connected to and upstream from the feed separator and the blowdown drum.

14. The system of claim 12, further comprising a compressor fluidly connected to and downstream from the flash drum and the amine stripper.

15. The system of claim 14, wherein the compressor is fluidly connected to and upstream from an injection well.

16. The system of claim 12, further comprising a filtration column fluidly connected to and downstream from the stripper column, and additionally fluidly connected to and upstream from the amine absorption unit, wherein the filtration column comprises one or more activated carbon beds.

17. The system of claim 16, wherein the filtration column further comprises particulate filters disposed on either side of the one or more activated carbon beds of the filtration column.

18. The system of claim 12, wherein the amine absorption unit comprises an amine absorption section and a water washing section in fluid communication with and disposed above the amine absorption section.

19. The system of claim 12, further comprising a re-boiler unit fluidly connected to the stripper column, wherein the re-boiler unit is both downstream and upstream from the stripper column.

20. The system of claim 12, wherein the blowdown drum is upstream from and fluidly connected to a liquid hydrocarbon refinery.
